(19) United States
(12) Patent Application Publication
(10) Pub. No.: US 2002/0134868 A1
(43) Pub. Date: Sep. 26, 2002

(54) Control apparatus for a boom irrigator, and a method and system relating thereto

(76) Inventor: Ole Charles Hansen, North Fremantle (AU)

Correspondence Address: MARGER JOHNSON & McCOLLOM, P.C., 1030 S.W. Morrison Street, Portland, OR, 97205, US

(21) Appl. No.: 10/085,865

(22) Filed: Feb. 27, 2002

(30) Foreign Application Priority Data
Feb. 27, 2001 (AU) PR 3395

(51) Int. Cl. B05B 3/18

(52) U.S. Cl. 239/728; 239/69

(57) ABSTRACT

A control apparatus (10) for a boom irrigator (80) comprises a microprocessor (16) and an associated memory (18) to store data corresponding to a desired distribution of fluid by the boom irrigator (80). The boom irrigator (80) has a plurality of control circuits (24). Each control circuit (24) is in communication with the microprocessor (16). Each control circuit (24) actuates at least one fluid control device, or solenoid, (82) in response to instructions received from the microprocessor (16). The microprocessor (16) is responsive to the data in the associated memory (18) and is arranged to communicate with the control circuits (24) to control the operation thereof in accordance with the data. The control apparatus (10) can be used in a system (12) for controlling a boom irrigator (80) which employs a computer system (14) that executes software allowing a user to input design distribution data for the fluid and to store the data. The computer system (14) is arranged to communicate the data to the associated memory (18) of the control apparatus (10).

### FIELD OF THE INVENTION

This invention relates to the field of boom irrigators, and in particular to a control apparatus for a boom irrigator, a system for controlling a boom irrigator, and a method for controlling a boom irrigator. The invention is applicable to both linear boom irrigators and to centre-pivot boom irrigators.

### BACKGROUND ART

Boom irrigators are used to water large areas of land. A boom irrigator is formed in sections, with each section having multiple nozzles to release water. Each section is supported on wheels and includes a motor for driving that section. Adjacent sections are articulated. A switch at the articulation joint determines when the adjacent sections are no longer parallel by more than a predetermined angle, which activates the motor on one of the sections to bring the sections back into line. In this manner, one section can be set to move at a fixed pace and the remaining sections will automatically move to remain in line. Boom irrigators having a length of 500 meters are not uncommon, and lengths of up to 800 meters have been used. Each section in a boom irrigator is typically 50 to 70 meters in length.

There are two main types of boom irrigators, namely linear and centre pivot. Linear boom irrigators move the entire boom irrigator over an area as a line. In order to supply water to the moving boom irrigator, either a hose connected to a water source needs to be provided to unreel as the boom irrigator moves, or alternatively a channel needs to be provided parallel to the boom irrigator at one end for the boom irrigator to draw water from.

Centre pivot boom irrigators make use of a fixed water source at one end of the boom irrigator, with the boom irrigator traversing a circle about the water source. Centre pivot boom irrigators are popular because of the ease with which water can be supplied to the boom irrigator from a fixed point. One problem with centre pivot boom irrigators is that if each section in the boom irrigator has the same number of nozzles and the nozzles are of the same type, the centre of the circle traversed by the boom irrigator receives more water than the areas near the circumference of the circle. A common way of addressing this problem is through the use of manual valves provided in each section of the boom irrigator that controls the flow of water to the nozzles in that section. A farmer can then adjust the manual valves to control the distribution of water along the length of the boom irrigator. Unfortunately, this method is cumbersome for use by the farmer and provides at best a coarse control over the water distribution. Since it is impractical for a farmer to adjust the valves on the boom irrigator as the boom irrigator is in motion, this method necessarily results in the same water distribution being applied equally around the circle.

Another solution to this problem involves providing electrically operated valves along the innermost sections of the boom irrigator and a programmable logic control (PLC) system on the boom irrigator. The PLC system switches each solenoid on and off at pre-programmed intervals in order to regulate the water supplied close to the centre pivot. The PLC systems tend to be restricted in their configurability due to inherent limitations in programming PLC systems. Further, a separate pair of wires is used to provide power to each solenoid, resulting in many wires being used along the boom irrigator. Since only the innermost sections of the boom irrigator are controlled, no control is provided over the remainder of the boom irrigator. The PLC system is arranged to regulate the water supply on the innermost sections at a predefined rate, and thus the same rate of water supply is provided along the circular path traversed by the boom irrigator.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of this invention, there is provided a control apparatus for a boom irrigator, comprising:

processor means and associated memory to store data corresponding to a desired distribution of fluid;

a plurality of control circuits provided along said boom irrigator, each control circuit being in communication with the processor means, each control circuit arranged to actuate at least one fluid control device associated therewith in response to instructions received from said processor means;

said processor means responsive to said data in the associated memory and arranged to communicate with the plurality of control circuits to control operation thereof according to said data.

Preferably, said control apparatus further comprises a position determining device in communication with said processor means, said processor means being responsive to said position determining device in accessing said data.

Preferably, said control apparatus further comprises position data, said processor means being responsive to said position data and said position determining device in accessing said data.

Preferably, said plurality of control circuits are in communication with said processor means via a common communications bus. In one arrangement, each control circuit has a unique identifier, among said plurality of identifiers, said processor means including said identifier to communicate with said control circuit.

Preferably, each control circuit includes an instruction buffer for receiving and storing instructions from said processor means, said control circuit responsive to said stored instructions in its buffer to actuate the associated fluid control devices.

Preferably, said fluid control devices are configured to fail in an open position.

Preferably, at least one of said fluid control devices is connected to a source of an additive fluid, said associated memory including further data corresponding to a desired distribution pattern for each additive fluid, said processor means responsive to said further data to communicate instructions to the control circuit associated with the fluid control devices connected to the source of an additive fluid to control operation thereof according to said further data.

Preferably, sensor means are provided to sense the moisture content of the soil traversed by the boom irrigator and transmit signals containing information about the sensed moisture content and said information it communicated to said processor means.

Preferably, transponder means are provided to receive signals from the sensor means and transmit signals in response thereto, the signals transmitted by said transponder means containing said information and being received by receiver means and said receiver means communicating said information to said processor means. Alternatively, the signals transmitted by said sensor means are received by a receiver means which communicates said information to said processor means.

Preferably, a weather station is provided to gather data about weather conditions, the said data so gathered being received by a receiver means which communicates said data to said processor means.

In accordance with a second aspect of this invention, there is provided a system for controlling a boom irrigator, comprising:

a control apparatus comprising:

processor means and associated memory storing data corresponding to a desired distribution of fluid;

a plurality of control circuits provided along said boom irrigator, each control circuit being in communication with the processor means, each control circuit arranged to actuate at least one fluid control device associated therewith in response to instructions received from said processor means;

said processor means responsive to said data in the associated memory and arranged to communicate with the plurality of control circuits to control operation thereof according to said data; and

a computer system executing software arranged to allow a user to input desired distribution data for said fluid and each said additive fluid and to store said data, said computer system arranged to communicate said data to said associated memory of said control apparatus.

Preferably, said control apparatus further comprises a position determining device in communication with said processor means, said processor means responsive to said position determining device in accessing said data.

Preferably, said control apparatus further comprises position data, said processor means being responsive to said position determining device in accessing said data.

Preferably, said associated memory includes a removable portion, said computer system including an interface arranged to receive said removable portion and to store said data thereon.

Preferably, said plurality of control circuits are in communication with said processor means via a common communications bus. In one arrangement, each control circuit has a unique identifier, among said plurality of identifiers, said processor means including said identifier in communications to said control circuit.

Preferably, each control circuit includes an instruction buffer for receiving and storing instructions from said processor means, said control circuit responsive to said stored instructions in its buffer to actuate the associated fluid control devices.

Preferably, said fluid control devices are configured to fail in an open position.

Preferably, at least one of said fluid control devices is connected to a source of an additive fluid, said associated memory including further data corresponding to a desired distribution pattern for each additive fluid, said processor means responsive to said further data to communicate instructions to the control circuit associated with the fluid control devices connected to the source of an additive fluid to control operation thereof according to said further data.

Preferably, sensor means are provided to sense the moisture content of the soil traversed by the boom irrigator and transmit signals containing information about the sensed moisture content and said information it communicated to said processor means.

Preferably, transponder means are provided to receive signals from the sensor means and transmit signals in response thereto, the signals transmitted by said transponder means containing said information and being received by receiver means and said receiver means communicating said information to said processor means. Alternatively, the signals transmitted by said sensor means are received by a receiver means which communicates said information to said processor means.

Preferably, a weather station is provided to gather data about weather conditions, the said data so gathered being received by a receiver means which communicates said data to said processor means.

In accordance with a third aspect of this invention, there is provided a method for controlling a boom irrigator, comprising:

storing data corresponding to a desired distribution of fluid over an area;

providing a plurality of control circuits along said boom irrigator;

instructing each control circuit to actuate at least one fluid control device associated therewith to distribute fluid over said area in accordance with said data.

Preferably, said method further comprises the step of determining a position of the boom, and using said position to access said data.

Preferably, said method further comprises the step of storing instructions in each control circuit, and using said stored instructions to actuate the associated fluid control devices.

Preferably, said method further comprises the steps of:

connecting at least one of said fluid control devices to a source of an additive fluid;

storing further data corresponding to a desired distribution pattern for each additive fluid; and

instructing the control circuit associated with the fluid control devices connected to the source of an additive fluid to control operation thereof according to said further data.

Preferably, said method further comprises the steps of:

sensing the moisture content of the soil traversed by the boom irrigator;

transmitting signals containing information about the sensed moisture content;

receiving the said signals; and

communicating said information to said processor means.

Preferably, said method further comprises the steps of:

receiving the signals transmitted by said sensor means at transponder means;

transmitting signals from said transponder means containing said information;

receiving said signals transmitted by said transponder means at receiver means; and

communicating said information from said receiver means to said processor means.

Alternatively, the method further comprises the steps of:

receiving the signals transmitted by said sensor means at receiver means; and

communicating said information from said receiver means to said processor means.

Preferably, said method further comprises the steps of:

gathering data about weather conditions;

receiving said data at a receiver means; and

communicating said data from said receiver means to said processor means.

Preferably, said method further comprises controlling the speed with which said boom irrigator traverses the ground to thereby control the amount of fluid distributed over said area.

### BRIEF DESCRIPTION OF THE DRAWINGS

This invention will now be described with reference to one embodiment thereof and the accompanying drawings, in which:

FIG. 1 shows a schematic view of an embodiment of a control apparatus for a boom irrigator in accordance with one aspect of the present invention;

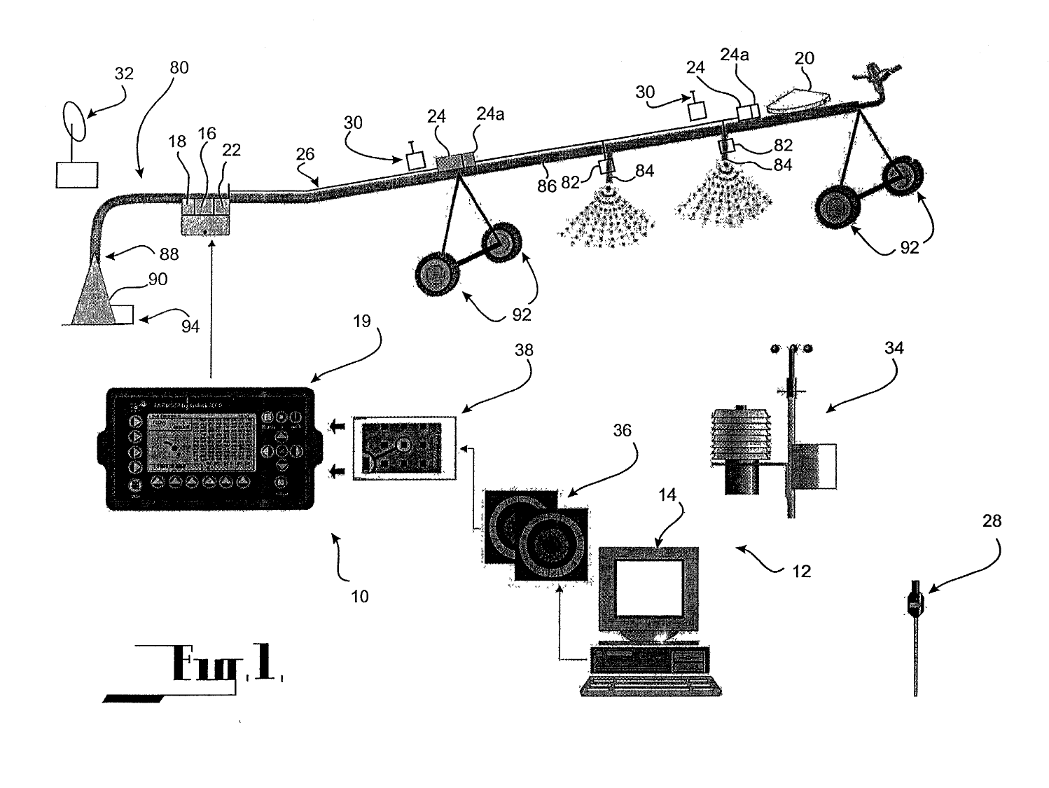

FIG. 2 shows a software application for managing distribution of water and additives in accordance with an embodiment of the present invention;

FIG. 3 shows a configuration screen for creating a new centre pivot used in the software application shown in FIG. 1;

FIG. 4 shows the software application of FIG. 1 with a pivot created;

FIG. 5 shows the software application of FIG. 1 with two data maps created;

FIG. 6 shows a data map editing screen of the software application shown in FIG. 1, which is shown editing the water distribution; and

FIG. 7 shows a data map editing screen of the software application shown in FIG. 1 in relation to editing the distribution of an additive.

### BEST MODE (S) FOR CARRYING OUT THE INVENTION

The embodiment relates to a control apparatus 10 for a boom irrigator 80, a system 12 for controlling the boom irrigator 80 comprising the control apparatus 10 and a computer system 14, and to a method relating thereto. The boom irrigator 80 itself, however, does not form part of the present invention.

The embodiment will be described with reference to centre pivot boom irrigators, however it should be appreciated that the invention is not limited to centre pivot boom irrigators.

In the embodiment, the control apparatus 10 comprises a microprocessor 16 and associated memory 18 which are housed within a controller unit 19, a global positioning system (GPS) device 20 and an interface circuit 22. The GPS device 20 is connected to the microprocessor 16 which periodically receives position information from the GPS device 20. In the embodiment, the interface circuit 22 is a serial RS-485 interface which is connected to the microprocessor 16. In other embodiments, alternative interface circuits may be used, for example optic fibre communications.

The control apparatus 10 also comprises control circuits 24 provided along sections of the boom irrigator 80. Typically, one control circuit 24 will be provided in each section of the boom irrigator 80, however multiple control circuits 24 can be provided in a single section if desired. Each control circuit 24 is associated with at least one solenoid 82 which controls the flow of water from nozzles 84 in that section. Each control circuit 24 includes an instruction buffer 24a for receiving and storing instructions received from the microprocessor 16. Each control circuit 24 is responsive to instructions stored in its buffer 24a to actuate associated solenoids 82. All of the control circuits 24 are connected to the RS-485 interface circuit 22 via a single set of communication wires 26.

The boom irrigator 80 is provided with a supply line 86, extending from the centre pivot 88, of the boom irrigator 80 in a conventional manner to supply water to the nozzles 84.

The boom irrigator 80 has a control device 90 at its centre pivot 88. The boom irrigator 80 is provided with wheels 92 to traverse the ground and the control device 90 is able to control the speed with which the boom irrigator 80 traverses the ground.

Soil moisture sensors, as exemplified by sensor 28, are provided at locations, as required, in the ground traversed by the boom irrigator 80. Transponders 30 are provided at spaced intervals along the boom irrigator 80 and a receiver unit 32 provided at the centre pivot 88. Each sensor 28 senses the moisture in the soil in its vicinity, and transmits a signal that is received by a transponder 30 as the boom irrigator 80 passes over the sensors 28. The signals transmitted by the sensors 28 contain information about the moisture content of the soil in their vicinity. The transponders 30 then transmit signals indicative of the soil moisture detected by the sensors 28. The signals transmitted by the transponders 30 are received by the receiver unit 32 which then relays the soil moisture content to the microprocessor 16.

Alternatively, the sensors 28 may be provided such that they transmit their signals directly to the receiver unit 32 which sends the information about the soil moisture content to the microprocessor 16.

The microprocessor 16 is able to adjust the watering distribution to take into account the soil moisture content. This may involve increasing or decreasing the amount of water sprayed from particular nozzles 84.

A weather station 34 may be provided to measure weather conditions, e.g. temperature, humidity, etc. The data gathered by the weather station 34 can be transmitted to the receiver unit 32 for relay to the microprocessor 16. The microprocessor 16 is able to adjust the watering distribution to take into account the data gathered by the weather station 34. This may involve increasing or decreasing the amount of water sprayed from particular nozzles 84.

One, or more, sources 94 of additives is provided. The additive is injected into the water supply line 26 feeding the nozzles 84. The source 94 of additives may be located at the centre pivot of the boom irrigator 80. Examples of additives that may be used are herbicides and insecticides.

In the embodiment, the GPS device 20 is located adjacent the end of the boom irrigator 80 that is not fixed at the centre pivot 88 of the boom irrigator 80. In other embodiments, multiple GPS devices 20 may be used for increased accuracy. The positions of the sections of the boom irrigator 80 are calculated from the known position of the centre pivot 88 and the position information received from the GPS device 20.

The position of each section of the boom irrigator 80 is used to access data stored in the associated memory 18 to determine the desired watering distribution and additive quantity. Once the desired watering is known for each section and the desired additive quantity is known, the microprocessor 16 issues instructions to each of the control circuits 24 via the RS-485 interface circuit 22. Each control circuit 24 includes an identifier that is unique amongst the control circuits 24 in use on the boom irrigator 80. The identifier uniquely identifies its respective control circuit 24 to the microprocessor 16. The unique identifier of each control circuit 24 is used by the microprocessor 16 to issue instructions to a specific control circuit 24.

In the embodiment, the user can select water regulation as a percentage from 0-100 per cent. This is implemented in the embodiment by the microprocessor 16 issuing instructions to each control circuit 24 every ten seconds such that each solenoid 82 associated with a particular control circuit 24 has a duty cycle that corresponds with the percentage indicated by the user.

To allow a user to manage the data regarding the desired distribution of water and additives, a computer system 14 is provided which executes computer software that allows a user to manage the data corresponding to the desired distribution of water and additives.

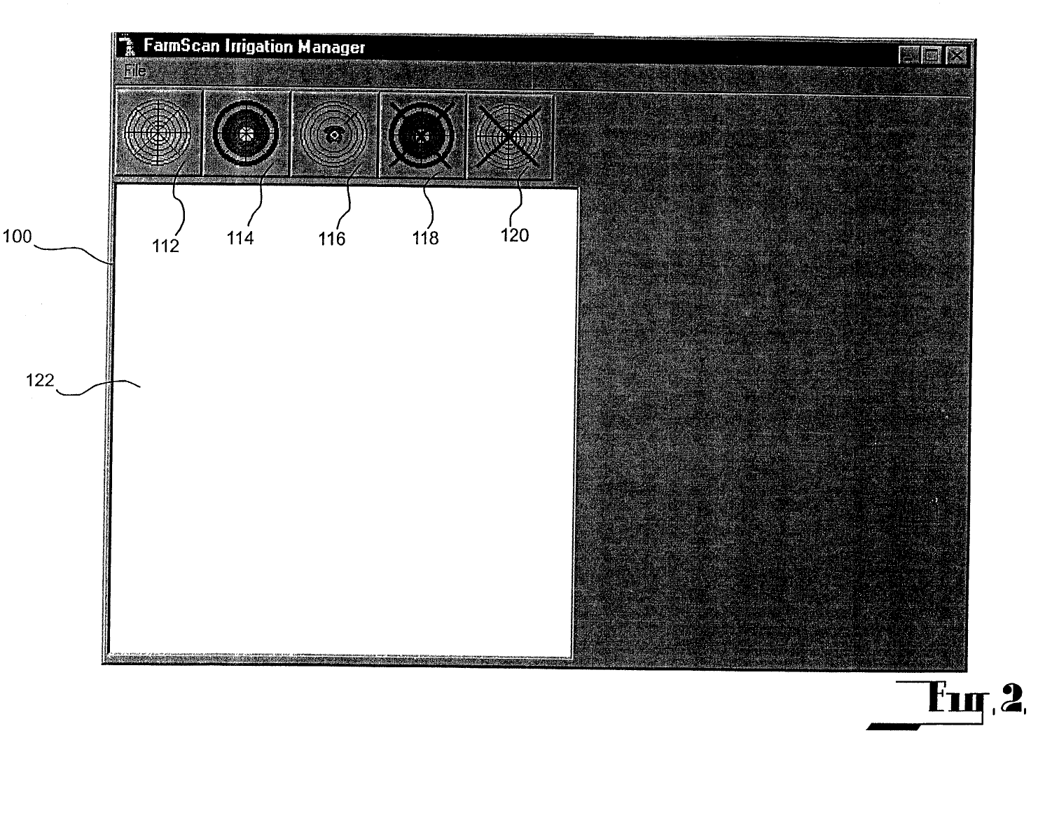

FIG. 2 shows the main window 100 of the software, which includes an add pivot button 112, an add data map button 114, a query pivot button 116, a delete irrigation data map button 118 and a delete pivot button 120. A display section 122 is also provided in the main window 100.

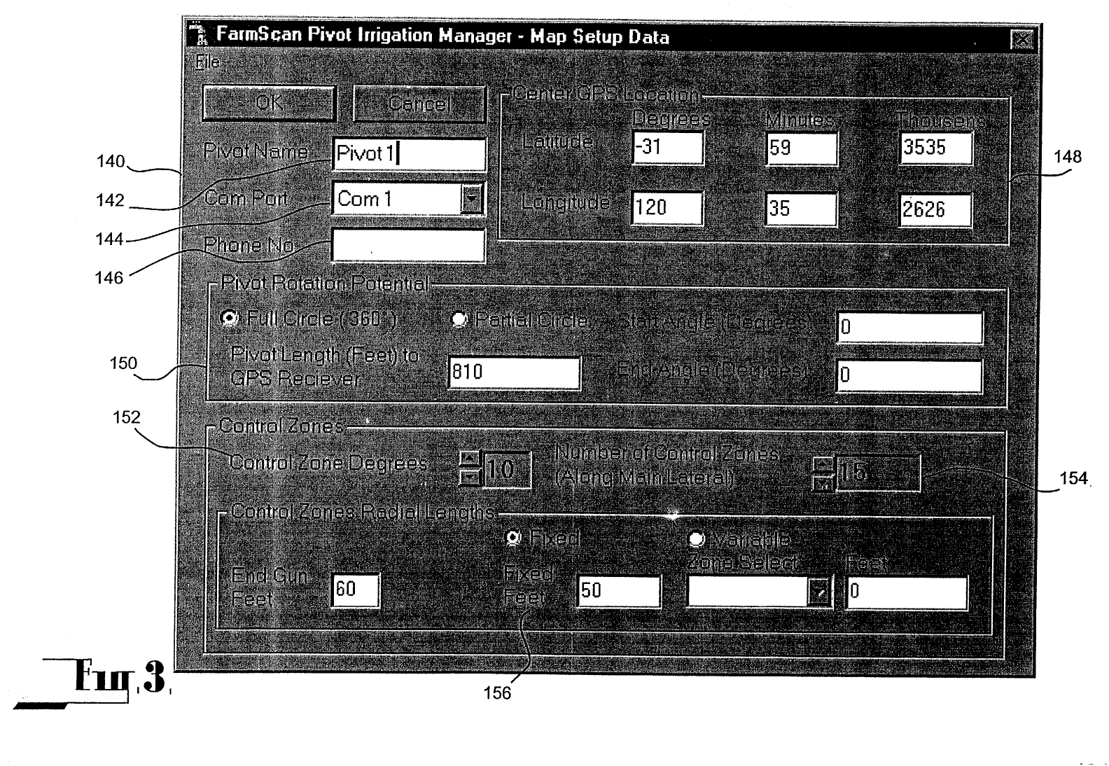

To manage the distribution of water and additives from a centre-pivot irrigator 80, a user selects the add pivot button 112, in response to which the computer software displays a map set up screen 140, which is shown in FIG. 3. Using the map set up screen, the user is able to enter a name for the centre-pivot irrigator at 142, which allows the user to differentiate between centre-pivot irrigators where multiple irrigators are managed using the software. The user is also able to indicate a communications port at 144 and telephone number at 146 which the computer uses to communicate with the controller 19 on the centre-pivot boom irrigator 80 via a modem and radio or satellite communications link when the query irrigator button 116 is pressed.

The latitude and longitude of the centre pivot 88 of the centre-pivot boom irrigator 80 is entered at 148. Whilst this is not required for the software to manage the map, it provides necessary information for the controller 19 in determining the position of the boom irrigator and accordingly which part of the data map to use in distributing the water and additives.

The user can also enter information regarding the pivot rotation of the boom irrigator 80 at 150, including whether the irrigator 80 traverses a full circle or only a partial circle, and in the event that a partial circle is traversed, the start and stop angles. The position of a GPS receiver device 20 on the boom irrigator 80 from the pivot centre 88 of the boom irrigator 80 is also indicated at 150. The length along the boom irrigator 80 that the GPS receiver device 20 is positioned is also used by the controller 19 in determining the position of the boom irrigator 80 in use.

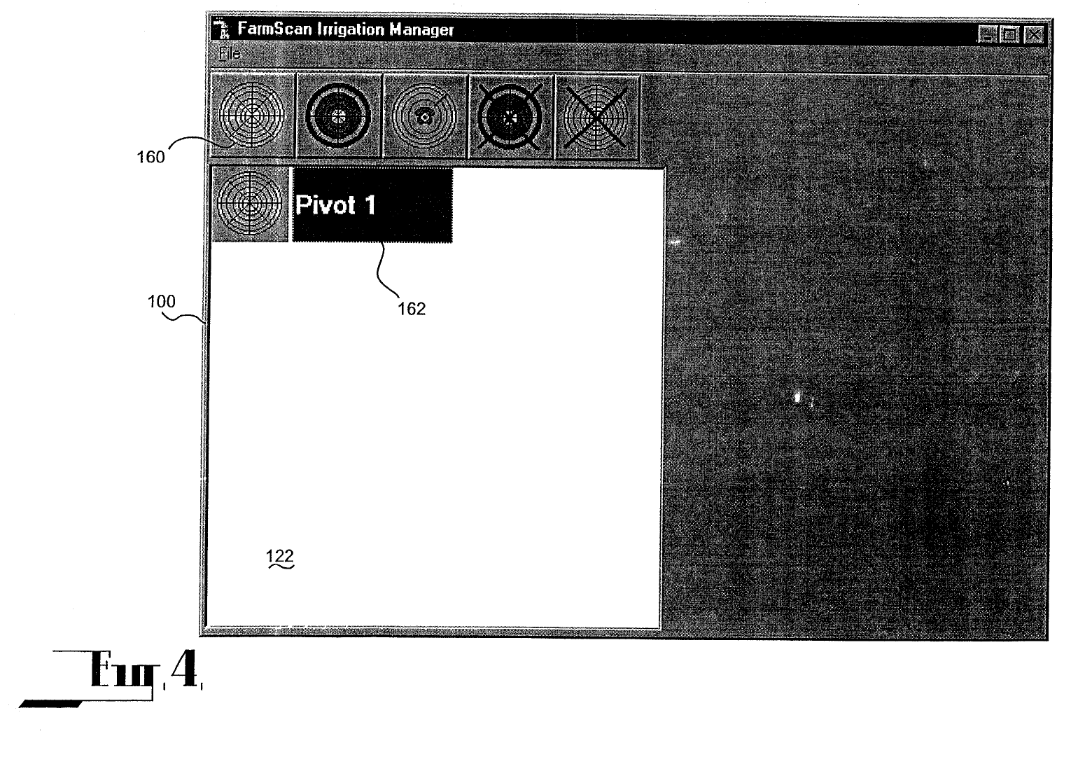

The user is also able to enter information concerning the angular resolution of the map by indicating the number of degrees over which the user requires control at 152. The user also enters the number of independent control circuits 24 operating along the boom irrigator 80 at 154. The user can enter the relative length of each zone controlled by a control circuit 24, including whether each control circuit 24 controls an equal length along the boom irrigator 80, or whether each control circuit 24 controls differing lengths along the boom irrigator 80 at 156. Once the information has been entered by the user, an icon 160 is shown in the display area 122 to represent the new centre-pivot boom irrigator 80. The icon 60 has an associated name 162 which is user-editable, as shown in FIG. 4.

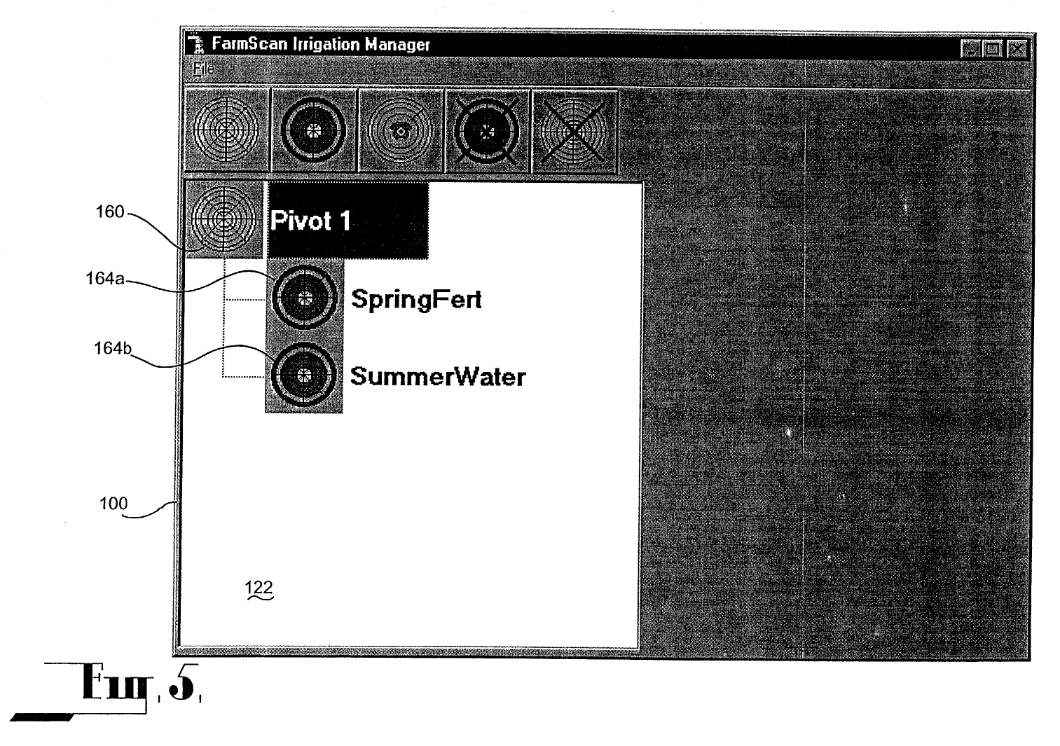

To add a data map to a particular centre-pivot irrigator icon 160, the user selects the icon 160 that he wishes to add a data map to and selects the add data map button 114. Multiple data maps are allowed for a single pivot irrigator icon 160. An example of this is shown in FIG. 5, in which two data map icons 164a and 164b associated with the centre-pivot irrigator icon 164. Each of the data map icons 164a and 164b has an associated name representing the information content of the data map. Thus, the user can conveniently create several different data maps corresponding to different types of water and additive distributions and can simply recall the desired data map for transfer to the controller 19.

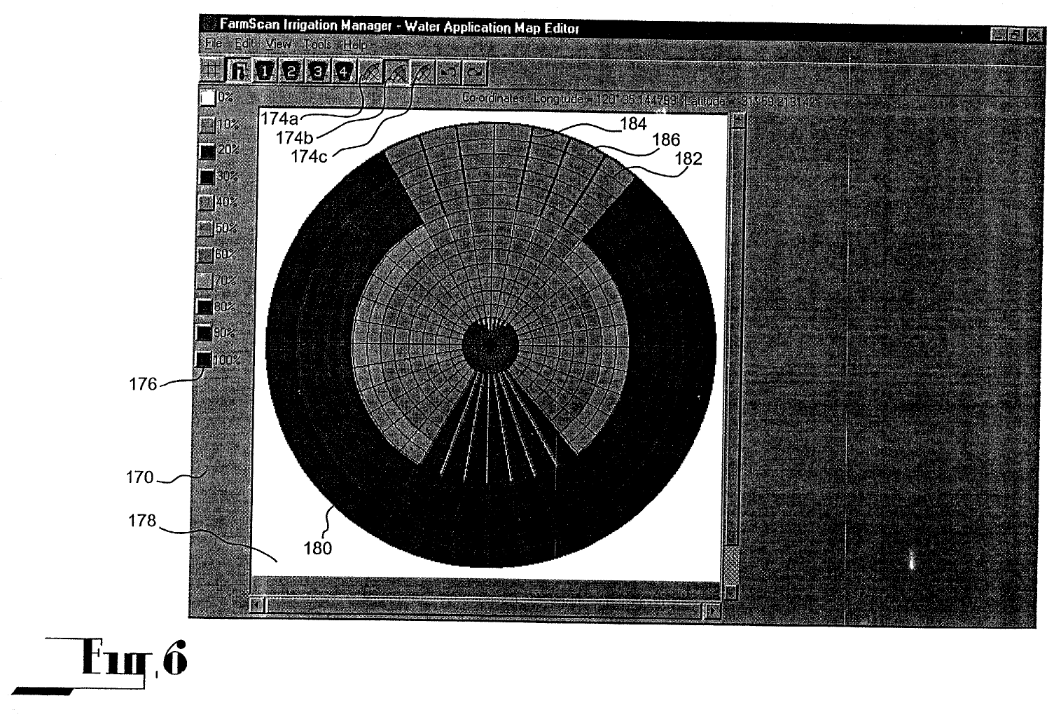

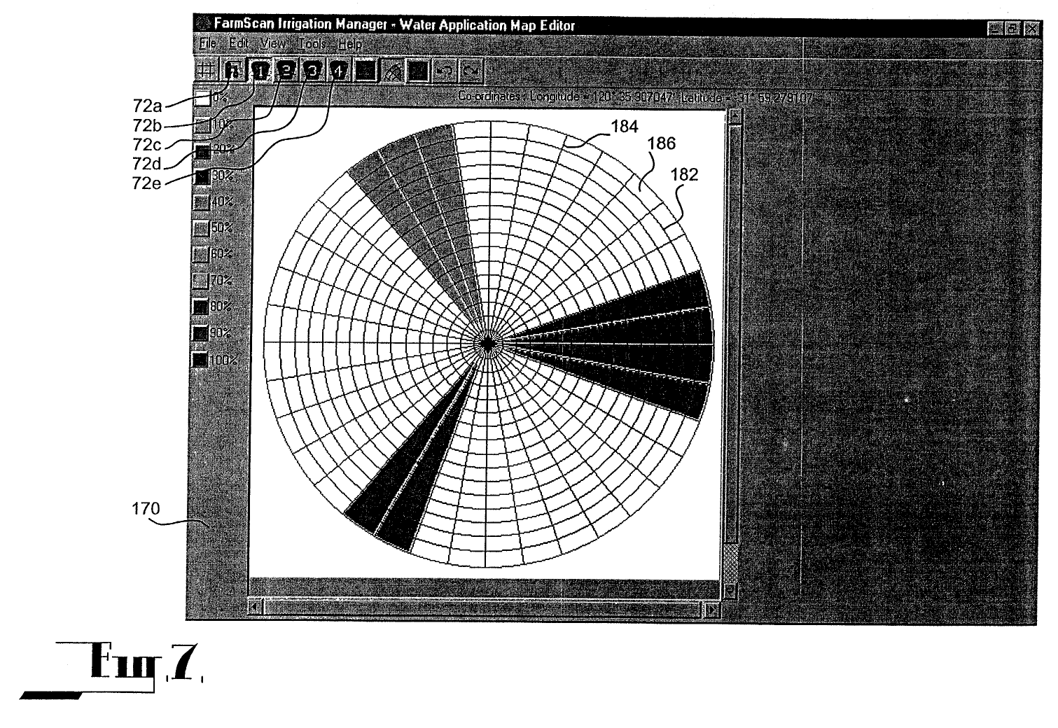

To manage the distribution of water and other additives in a data map, the user simply selects the data map icon 164a or 164b of the data map he or she wishes to maintain. Upon doing so, the user is presented with the data map editor screen 170 which is shown in FIGS. 6 and 7. FIG. 6 shows the data map editor screen 170 covering the distribution of water present in the data map, and FIG. 7 shows the data map editor screen 170 showing the distribution of a first additive. In total, four additives can be administered using the data map editor. A user selects whether they wish to view and edit the water distribution or any of the four additive distributions using the selection button 172a-172e.

The data map editor screen 170 also includes selection buttons 174a-174c, which correspond with the actions of a user being applied to all segments in a one segment wide annulus that includes the selected segment, a one segment wide radial arc including the selected segment, or the selected segment only, respectively. This provides the user with a degree of control and convenience in indicating the desired distribution. The data map editor screen 170 also includes percentage selection buttons shown at 176, which provide predefined percentage distributions and corresponding colour indications. The percentage distribution buttons 176 allow the user to select a desired percentage to be applied to a data map.

The data map editor screen 170 also includes a display portion 178 that includes a map 180 of the area traversed by the boom irrigator 80. The map 180 consists of a plurality of concentric circles 182, the number of which is determined by the number of independent control circuits 24 indicated by the user at 154. The map 180 also includes a plurality of radial lines 184 which are spaced apart according to the number of degrees in each area of control indicated by the user at 152. The relative spacing between the concentric circles 182 is determined by the radial length controlled by each control circuit 24 input by the user at 156. In the embodiment, the map 180 is shown as a complete circle, however where a partial circle is indicated by the user at 150, then the map 180 will also reflect this. A user is able to indicate a desired distribution by using the control buttons 174a-174c and the percentage selection buttons 176 in order to fill arcs, annuluses and individual segments 186.

In the embodiment, only the control button 174b is available when a user is editing the distribution map of the additives corresponding to selection buttons 172b-172e. This is because in the embodiment, additives are controlled at the centre pivot 88 and are fed into the water supply 86 for the entire boom irrigator 80. Accordingly, any additive injected into the water supply 86 will be distributed evenly throughout the length of the boom irrigator 80. Note that in other embodiments, circuit-specific control of each additive may be provided if required, however this introduces an additional degree of complexity in distributing the additives to each control circuit 24.

It should be readily apparent to a skilled addressee that the apparatus, system and method of the embodiment provides a convenient way for a person to control the distribution of water and several additives of a boom irrigator 80. The data maps 36 administered using the computer software system 14 can be transferred to the associated memory 18 of the microprocessor 16 in the controller 19 using any known interface, e.g. a reusable data card 36, or even via a radio-wave communication system.

The control device 90 can be used to adjust the speed of the boom irrigator 80 above or below a preselected reference speed. This effectively enables the watering times for selected sections of ground to be increased or decreased, above a preselected level.

It should be appreciated that the scope of this invention is not limited to the particular embodiment described above. For instance, although the embodiment has been described with reference to centre-pivot boom irrigators, it should be readily apparent that the invention can be readily adapted to other forms of boom irrigators.

I claim:

1. A control apparatus for a boom irrigator comprising:
processor means and associated memory to store data corresponding to a desired distribution of fluid;
a plurality of control circuits provided along said boom irrigator, each control circuit being in communication with the processor means, each control circuit arranged to actuate at least one fluid control device associated therewith in response to instructions received from said processor means;
said processor means responsive to said data in the associated memory and arranged to communicate with the plurality of control circuits to control operation thereof according to said data.

2. A control apparatus according to claim 1, further comprising a position determining device in communication with said processor means, said processor means being responsive to said position determining device in accessing said data.

3. A control apparatus according to claim 2, further comprising position data, said processor means being responsive to said position data and said position determining device in accessing said data.

4. A control apparatus according to claim 1, wherein said plurality of control circuits are in communication with said processor means via a common communications bus and each control circuit has a unique identifier, among said plurality of identifiers, said processor means including said identifier to communicate with said control circuit.

5. A control apparatus according to claim 1, wherein each control circuit includes an instruction buffer for receiving and storing instructions from said processor means, said control circuit responsive to said stored instructions in its buffer to actuate the associated fluid control devices.

6. A control apparatus according to claim 1, wherein at least one of said fluid control devices is connected to a source of an additive fluid, said associated memory including further data corresponding to a desired distribution pattern for each additive fluid, said processor means responsive to said further data to communicate instructions to the control circuit associated with the fluid control devices connected to the source of an additive fluid to control operation thereof according to said further data.

7. A control apparatus according to claim 1, wherein sensor means are provided to sense the moisture content of the soil traversed by the boom irrigator and transmit signals containing information about the sensed moisture content and said information it communicated to said processor means.

8. A control apparatus according to claim 7, wherein transponder means are provided to receive signals from the sensor means and transmit signals in response thereto, the signals transmitted by said transponder means containing said information and being received by receiver means and said receiver means communicating said information to said processor means.

9. A control apparatus according to claim 7, wherein the signals transmitted by said sensor means are received by a receiver means which communicates said information to said processor means.

10. A control apparatus according to claim 1, wherein a weather station is provided to gather data about weather conditions, the said data so gathered being received by a receiver means which communicates said data to said processor means.

11. A system for controlling a boom irrigator comprising:
a control apparatus comprising:
processor means and associated memory storing data corresponding to a desired distribution of fluid;
a plurality of control circuits provided along said boom irrigator, each control circuit being in communication with the processor means, each control circuit arranged to actuate at least one fluid control device associated therewith in response to instructions received from said processor means;
said processor means responsive to said data in the associated memory and arranged to communicate with the plurality of control circuits to control operation thereof according to said data; and
a computer system executing software arranged to allow a user to input desired distribution data for said fluid and each said additive fluid and to store said data, said computer system arranged to communicate said data to said associated memory of said control apparatus.

12. A system for controlling a boom irrigator according to claim 11, further comprising a position determining device in communication with said processor means, said processor means responsive to said position determining device in accessing said data.

13. A system for controlling a boom irrigator according to claim 12, further comprising position data, said processor means being responsive to said position determining device in accessing said data.

14. A system for controlling a boom irrigator according to claim 11, wherein said associated memory includes a removable portion, said computer system including an interface arranged to receive said removable portion and to store said data thereon.

15. A system for controlling a boom irrigator according to claim 11, wherein said plurality of control circuits are in communication with said processor means via a common communications bus and each control circuit has a unique identifier, said processor means including said identifier in communications to said control circuit.

16. A system for controlling a boom irrigator according to claim 11, wherein each control circuit includes an instruction buffer for receiving and storing instructions from said processor means, said control circuit responsive to said stored instructions in its buffer to actuate the associated fluid control devices.

17. A system for controlling a boom irrigator according to claim 11, wherein at least one of said fluid control devices is connected to a source of an additive fluid, said associated memory including further data corresponding to a desired distribution pattern for each additive fluid, said processor means responsive to said further data to communicate instructions to the control circuit associated with the fluid control devices connected to the source of an additive fluid to control operation thereof according to said further data.

18. A system for controlling a boom irrigator according to claim 11, wherein sensor means are provided to sense the moisture content of the soil traversed by the boom irrigator and transmit signals containing information about the sensed moisture content and said information it communicated to said processor means.

19. A system for controlling a boom irrigator according to claim 18, wherein transponder means are provided to receive signals from the sensor means and transmit signals in response thereto, the signals transmitted by said transponder means containing said information and being received by receiver means and said receiver means communicating said information to said processor means.

20. A system for controlling a boom irrigator according to claim 18, wherein the signals transmitted by said sensor means are received by a receiver means which communicates said information to said processor means.

21. A system for controlling a boom irrigator according to claim 11, wherein a weather station is provided to gather data about weather conditions, the said data so gathered being received by a receiver means which communicates said data to said processor means.

22. A method for controlling a boom irrigator comprising:
storing data corresponding to a desired distribution of fluid over an area;
providing a plurality of control circuits along said boom irrigator;
instructing each control circuit to actuate at least one fluid control device associated therewith to distribute fluid over said area in accordance with said data.

23. A method according to claim 22, wherein it further comprises the step of determining a position of the boom, and using said position to access said data.

24. A method according to claim 22, wherein it further comprises the step of storing instructions in each control circuit, and using said stored instructions to actuate the associated fluid control devices.

25. A method according to claim 22, wherein it further comprises the steps of:
connecting at least one of said fluid control devices to a source of an additive fluid;
storing further data corresponding to a desired distribution pattern for each additive fluid; and
instructing the control circuit associated with the fluid control devices connected to the source of an additive fluid to control operation thereof according to said further data.

26. A method according to claim 22, wherein it further comprises the steps of:
sensing the moisture content of the soil traversed by the boom irrigator;
transmitting signals containing information about the sensed moisture content;
receiving the said signals; and
communicating said information to said processor means.

27. A method according to claim 26, wherein it further comprises the steps of:
receiving the signals transmitted by said sensor means at transponder means;
transmitting signals from said transponder means containing said information;
receiving said signals transmitted by said transponder means at receiver means; and
communicating said information from said receiver means to said processor means.

28. A method further according to claim 26, wherein it further comprises the steps of:
receiving the signals transmitted by said sensor means at receiver means; and
communicating said information from said receiver means to said processor means.

29. A method according to claim 22, wherein it further comprises the steps of:
gathering data about weather conditions;
receiving said data at receiver means; and
communicating said data from said receiver means to said processor means.

30. A method according to claim 22, wherein it further comprises controlling the speed with which said boom irrigator traverses the ground to thereby control the amount of fluid distributed over said area.
